(19) United States
(12) Patent Application Publication
(10) Pub. No.: US 2008/0148002 A1
(43) Pub. Date: Jun. 19, 2008

(54) Method and Apparatus for Allocating A Dynamic Data Structure

(76) Inventor: Matthew D. Fleming, Austin, TX (US)

Correspondence Address: HAMILTON & TERRILE, LLP;IBM Austin, P.O. BOX 203518, AUSTIN, TX, 78720, US

(21) Appl. No.: 11/609,931

(22) Filed: Dec. 13, 2006

(51) Int. Cl. G06F 12/02

(52) U.S. Cl. 711/170; 711/E12.002

(57) ABSTRACT

A method, system and program are provided for allocating a data structure to memory by selecting a page of memory having a free entry, allocating the free entry for exclusive storage of a data element in the data structure, and then updating control information on the selected page with management data specifying that the free entry is allocated. In a selected embodiment, the page of memory is part of a heap of memory pages which is organized so that a page, having at least one free entry and fewer free entries than any other page in the heap, is located at the top of the heap. This allows allocations to proceed first with pages having fewer free entries, thereby promoting pages having all free entries.

### BACKGROUND OF THE INVENTION

1. Field of the Invention

The present invention is directed in general to the field of data processing systems. In one aspect, the present invention relates to memory management within data processing systems.

2. Description of the Related Art

Data processing systems typically include one or more central processing units (CPU), one or more levels of caches, one or more memory devices, and input/output (I/O) mechanisms, all interconnected via an interconnection of buses and bridges. In addition to these hardware components, data processing systems also include one or more software (or firmware) components, such as an Operating System (OS) and one or more programs which interact with the OS. Typically, the OS allocates and deallocates memory for use by the programs using virtual memory addressing techniques to support a very large set of addresses (referred to as the address space) which are divided into pages.

Different approaches for memory allocation have been proposed. With static memory allocation, memory is allocated at compile-time before the associated program is executed. In contrast, dynamic memory allocation allocates memory for use in a program during the runtime of that program by distributing ownership of limited memory resources among many pieces of data and code. Because a dynamically allocated region of memory (or “object”) remains allocated only until explicitly deallocated, this technique is preferred when working with large data structures (e.g., data structures having 2²⁴ elements) because it reduces memory waste by deallocating memory when it is no longer needed.

A variety of solutions have been proposed for fulfilling a dynamic memory allocation request, including using stacks (e.g., a LIFO linked list) to organize allocations, buddy block allocators, free lists which connect unallocated regions of memory together in a linked list, and heap-based memory allocation. However, these solutions suffer from a number of drawbacks. For example, when additional management data is used to manage large dynamic data structures to rapidly locate a free entry for use, the additional management data is stored as a separate page memory array which unnecessarily consumes memory when it remains allocated even though the referenced data elements are no longer allocated. Another drawback with prior solutions is that deallocated memory (e.g., memory that was allocated to the data structure and that is no longer needed) can only be reclaimed by using a time-consuming process of rearranging the individual data elements in the structure, a process which limits the ability to quickly reclaim deallocated memory. Yet another drawback with prior dynamic memory allocation techniques is that they tend to generate fragmented memory pages in which some elements are allocated and some elements are free (unallocated). Fragmented memory pages pose a problem for specialized data structures requiring pinned pages that must be stored in system memory and not paged out (or when a bolted entry in the hardware page table is needed), because these pages must remain pinned until they are completely free.

Accordingly, there is a need for a system and method of dynamically allocating memory using management data to efficiently and quickly locate free entries for allocation. In addition, there is a need for a system and method to rapidly and efficiently reclaim deallocated memory. There is also a need for a dynamic memory allocation technique which results in whole pages of free elements. Further limitations and disadvantages of conventional memory management solutions will become apparent to one of skill in the art after reviewing the remainder of the present application with reference to the drawings and detailed description which follow.

### SUMMARY OF THE INVENTION

A dynamic memory allocation system and methodology are provided for efficiently storing large dynamic data structures in a page memory system, where the data structures can be rapidly allocated, deallocated and reclaimed without rearranging the individual data elements in memory. By storing management data on the same page with its corresponding data structure, the management data and the data it manages can be allocated and deallocated in single pages, thereby reducing the memory storage overhead associated with storing the management data as a separate array on a different page. In addition, a modified heap order is used to rapidly allocate and free individual data elements (and the associated management data) from page memory and to generate defragmented memory pages where all the elements are free.

In various embodiments, a dynamic data structure may be allocated in memory using the methodologies and/or apparatuses described herein, which may be implemented in a data processing system with computer program code comprising computer executable instructions. In whatever form implemented, a request to allocate a first data structure is received during operation of a data processing system, where the first data structure includes at least a first data element. In response, a page of memory is selected which has at least one free entry that is available for storing at least the first data element. To assist with efficient allocation of memory pages, the memory pages may be organized in a heap structure on the basis of how many free entries are contained on each page, such as using a key value on each page which identifies how many free entries are contained by the page. In a selected embodiment, the heap of memory pages are organized so that a page, having at least one free entry and fewer free entries than any other page in the heap, is located at the top of the heap. With this organization, the memory pages selected for allocation. From the selected page, the free entry is allocated for exclusive storage of the first data element, such as by scanning an indirect and/or direct allocation bitmap for the first page to select an entry that is available for allocation and then returning an address for an entry selected for exclusive storage of the first data element. To reflect the allocation, control information stored on the page of memory is updated with management data specifying that the first free entry is allocated on the page. For example, the control information may be updated by decrementing a key value for the first page to identify how many free entries are contained by the first page. Independently of the allocation operations, a data structure stored in a specified entry of a memory page may be deallocated by updating control information stored on the memory page that stores the data structure with management data specifying that the specified entry of the memory page is deallocated. For example, the control information may be updated to reflect a deallocation by setting a bit corresponding to the given entry in an allocation bitmap for the memory page, and decrementing a key value for the memory page to identify how many free entries are contained by the memory page.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIG. 1 illustrates a computer architecture that may be used within a data processing system in which the present invention may be implemented;

FIG. 2 illustrates a plurality of memory pages where each page includes management data corresponding to the data elements stored on the page;

FIG. 3 illustrates a plurality of memory pages that are organized in a memory heap by key value; and

FIG. 4 is a logical flowchart of the steps used to allocate and deallocate data elements from a data structure to and from pages in a memory heap.

### DETAILED DESCRIPTION

A method, system and program are disclosed for dynamically allocating a data structure in memory to reduce memory waste by keeping management data on the same page as the data structure element being managed when the data structure element requires less memory than the hardware page size. By ordering the pages in a modified heap order so that memory allocations are made from pages with the fewest free entries (though not including pages with no free entries), individual data elements are rapidly allocated and freed in a way that promotes pages with all-free entries.

Various illustrative embodiments of the present invention will now be described in detail with reference to the accompanying figures. It will be understood that the flowchart illustrations and/or block diagrams described herein can be implemented in whole or in part by dedicated hardware circuits, firmware and/or computer program instructions which are provided to a processor of a general purpose computer, special purpose computer, or other programmable data processing apparatus to produce a machine, such that the instructions (which execute via the processor of the computer or other programmable data processing apparatus) implement the functions/acts specified in the flowchart and/or block diagram block or blocks. In addition, while various details are set forth in the following description, it will be appreciated that the present invention may be practiced without these specific details, and that numerous implementation-specific decisions may be made to the invention described herein to achieve the device designer's specific goals, such as compliance with technology or design-related constraints, which will vary from one implementation to another. While such a development effort might be complex and time-consuming, it would nevertheless be a routine undertaking for those of ordinary skill in the art having the benefit of this disclosure. For example, selected aspects are shown in block diagram form, rather than in detail, in order to avoid limiting or obscuring the present invention. In addition, some portions of the detailed descriptions provided herein are presented in terms of algorithms or operations on data within a computer memory. Such descriptions and representations are used by those skilled in the art to describe and convey the substance of their work to others skilled in the art. Various illustrative embodiments of the present invention will now be described in detail below with reference to the figures.

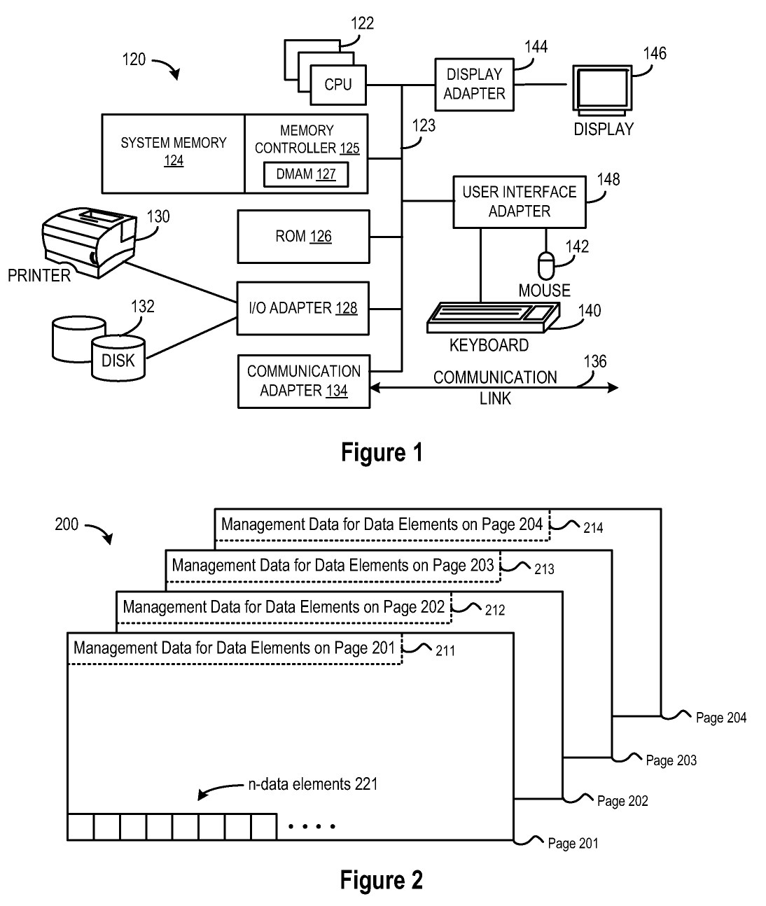

Referring to FIG. 1, a diagram depicts a computer architecture of a data processing system 120 in which selected embodiments of the present invention may be implemented. The depicted data processing system 120 contains one or more central processing units (CPUs) 122, a system memory 124, and a system bus 123 that couples various system components, including the processing unit(s) 122 and the system memory 124.

System memory 124 may be implemented with computer storage media in the form of non-volatile memory and/or volatile memory in the form of a collection of dynamic random access memory (DRAM) modules that store data and instructions that are immediately accessible to and/or presently operated on by the processing unit(s) 122. System memory may also have an associated memory controller 125 for controlling access to and from system memory 124. In an example implementation, the memory controller 125 includes a dynamic memory allocation module (DMAM) 127 for identifying, allocating and freeing desired memory within system memory 124.

The depicted system bus 123 may be implemented as a local Peripheral Component Interconnect (PCI) bus, Accelerated Graphics Port (AGP) bus, Industry Standard Architecture (ISA) bus, or any other desired bus architecture. System bus 123 is connected to a communication adapter 134 that provides access to communication link 136, a user interface adapter 148 that connects various user devices (such as keyboard 140, mouse 142, or other devices not shown, such as a touch screen, stylus, or microphone), and a display adapter 144 that connects to a display 146. The system bus 123 also interconnects the system memory 124, read-only memory 126, and input/output adapter 128 which supports various I/O devices, such as printer 130, disk units 132, or other devices not shown, such as an audio output system, etc. In a selected embodiment, the I/O adapter 128 is implemented as a small computer system interface (SCSI) host bus adapter that provides a connection to other removable/non-removable, volatile/nonvolatile computer storage media, such as disk units 132 which may be implemented as a hard disk drive that reads from or writes to non-removable, nonvolatile magnetic media, a tape drive that reads from or writes to a tape drive system, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

As will be appreciated, the hardware used to implement the data processing system 120 can vary, depending on the system implementation. For example, hardware or peripheral devices, such as flash read-only memory (ROM), equivalent nonvolatile memory, or optical disk drives and the like, may be used in addition to or in place of the hardware depicted in FIG. 1. In addition to being able to be implemented on a variety of hardware platforms, the present invention may be implemented in a variety of software environments so that different operating systems (such as Microsoft, Linux, and Java-based runtime environments) are used to execute different program applications (such as a word processing, graphics, video, or browser program). In other words, while different hardware and software components and architectures can be used to implement different data processing systems (such as a Web-enabled or network-enabled communication device or a fully featured desktop workstation), such hardware or architectural examples are not meant to imply limitations with respect to the dynamic memory allocation techniques disclosed herein.

Referring now to FIG. 2, there is depicted a block diagram representation of the system memory 200 which has been divided into a plurality of partitions or pages 201-204 which are used to dynamically allocate memory. As depicted, a first page 201 includes control information 211 in the form of management data for the data elements 221 stored on the page 201. Similarly, the other pages 202, 203, 204, etc. include respective control information 212, 213, 214, etc. which acts as management data for the data elements stored on each of the respective pages. With this approach, the management data for a large dynamic data structure is divided into a plurality of partitions and stored non-contiguously so that each management data partition (e.g., 211) is stored on a page (e.g., 201) along with the subset of the data elements (e.g., 221) from the data structure that are managed by the management data partition (e.g., 211). The use of non-contiguous management data allows the management data and the data it manages to be allocated and freed in single pages as needed, thereby reducing the overhead associated with maintaining a separate array of management data that is allocated on separate pages, even if the associated data elements are no longer allocated.

While the data that is managed can be any suitable data structure, selected embodiments of the present invention include the managed data as part of a linked list. An example implementation of a linked list structure for each element would be as follows:

```
struct link_entry {
    data_t  data;
    struct link_entry *next;
};
```

where “struct link-entry” is the name of the managed object, “data_t data” is the data element on the page, and “struct link_entry*next” contains the pointer to the next elements on the list. Because, with this approach, the data that is managed is entirely opaque to the management data structure, and only the size of the data managed is relevant for determining the number of elements that will fit in a page.

Continuing with the foregoing illustrative example, a data layout for a 4k page (with the data_t and pointer both being 64 bits) containing both management data and corresponding data elements for that page could be structured as follows:

```
struct link_entry_page_4K {
    int  numfree;
    int  heapidx;
    struct link_entry_page_4K  * parent;
    struct link_entry_page_4K  *child[2];
    long ele_free2[1];
    long ele_free[4];
    struct link_entry element[251];
};
```

where “struct link_entry page_{—}4K” is the name of the data structure describing a given page, “int numfree” is the key value indicating the number of free elements in the page, “long ele_free[4]” is a direct allocation bitmap identifying which data elements on the page are free (or conversely, allocated) and “struct link_entry element[251]” is the 251 data elements on the page. Though an entry in the bitmap is described as being “set” (e.g., “1”) when the entry is free and “re-set” (e.g., “0”) when the entry is allocated, it will be appreciated that the reverse scheme can also be used to identify which entries are free or allocated.

When allocating data elements from a given page, each entry in the direct allocation bitmap may be searched to determine if there is a free element available for allocation. However, with larger memory page sizes or smaller sizes of the data being managed, a significant amount of time and resources can be consumed to search the entire direct allocation bitmap. Accordingly, selected embodiments of the present invention include one or more upper level indirect bitmaps in the management data to identify which words in the direct allocation bitmap have at least one free entry. For example, if the direct allocation bitmap includes 251 bits (one for each element stored on the page), then this bitmap may be grouped into four 64-bit words and a second level bitmap (“long ele_free2[1]”) may be used as an indirect allocation bitmap to describe which of four 64-bit words in the direct allocation bitmap contain at least one free entry that is available for allocation to a data element. By implementing the indirect allocation bitmap in the management data as a single 64-bit word, a two-pass search may be used to find a free element, where the first search pass searches the indirect allocation bitmap to identify which word(s) in the direct allocation bitmap have at least one free element, and the second search pass searches only the identified word in the direct allocation bitmap to identify the free element(s). Given a random distribution of free entries on a page, the two-pass search technique will, on average, reduce the time required to locate a free entry on a page as compared to using a single pass through the entire direct allocation bitmap.

In accordance with selected embodiments of the present invention, each page is included as part of a heap structure of pages for purposes of controlling the sequence of memory allocation for each page. The timing of deallocation events is not controlled by the embodiment and can be considered to be essentially random events. To this end, the management data for a page also includes a reference identifying the parent page (“struct link_entry_page_{—}4K*parent”) and references identifying the two child pages (“struct link_entry_page_{—}4K*child[2]”). In addition, an index for the referenced page within the heap (“int heapidx”) may also be included in the management data. With these references, the management data may be used to identify and control the location of the page in the heap.

As will be appreciated, this management control structure can be used with other page sizes. For example, management data for a 64K page could be structured as follows:

```
struct link_entry_page_64K {
    int  numfree;
    int  heapidx;
    struct link_entry_page_64K  * parent;
    struct link_entry_page_64K  *child[2];
    long ele_free2[1];
    long ele_free[64];
    struct link_entryelement[4061];
};
```

where “struct link_entry_page_{—}64K” is the name of the management data for the 64K page, “int numfree” is the key value indicating the number of free elements in the page, “long ele_free[64]” is a direct allocation bitmap identifying which data elements on the 64K page are free (or conversely, allocated) and “struct link_entry element[4061]” is the 4061 data elements on the page.

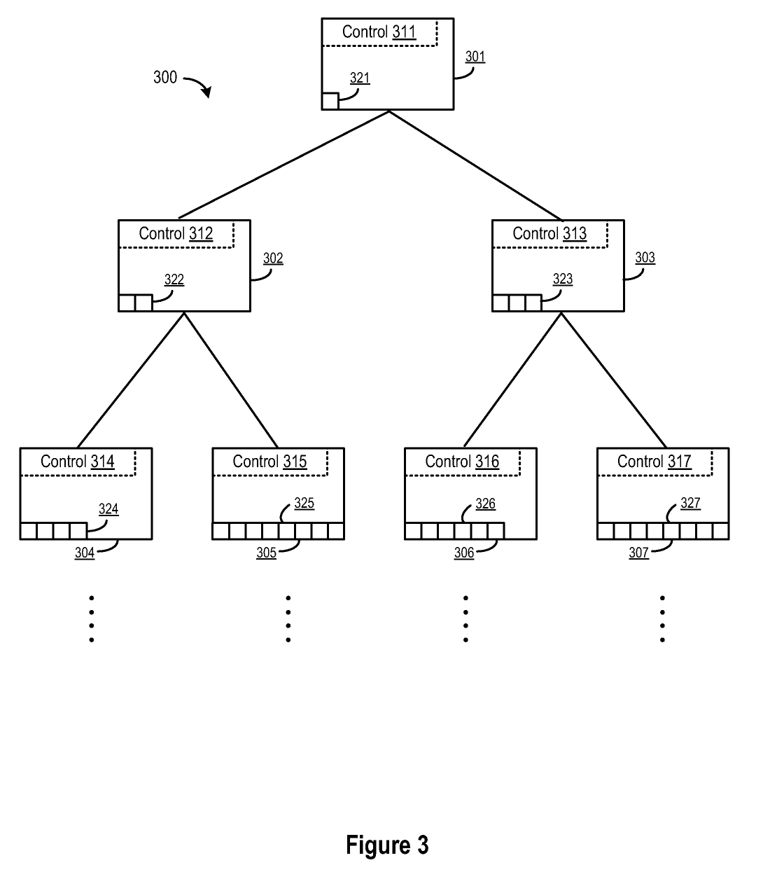

For purposes of rapidly allocating memory for a data structure, as well as reclaiming memory that was allocated to a data structure that is no longer needed, the memory pages may be organized as a modified heap structure which uses the key value (identifying the number of free data elements on each page) to sort the pages as a min-heap. An example heap structure 300 is depicted in FIG. 3, which illustrates a plurality of memory pages that are organized by key value so that the pages having the fewest free entries are at the top of the heap, while pages having more free entries have a lower rank on the heap. In the depicted heap structure 300, a first page 301 is positioned at the top of the heap by virtue of having the fewest free entries 321 available for allocation. The positioning in the heap may be determined by the key value contained in the control information 311 the page 301 which indicates that there is only one free entry on the page 301. Each of the child pages 302, 303 have more free entries 322, 323 than the first page 301, and are relatively positioned in the heap on the basis of the key values contained in the control information 312, 313, which indicate respectively that there are two free entries on the second page 302 and three free entries on the third page 303. In turn, the child pages 304, 305 to the second page 302 are positioned in the heap by virtue of the key value indication in the respective control information fields 314, 315, while the child pages 306, 307 to the third page 303 are positioned in the heap by virtue of the key value indication in the respective control information fields 316, 317.

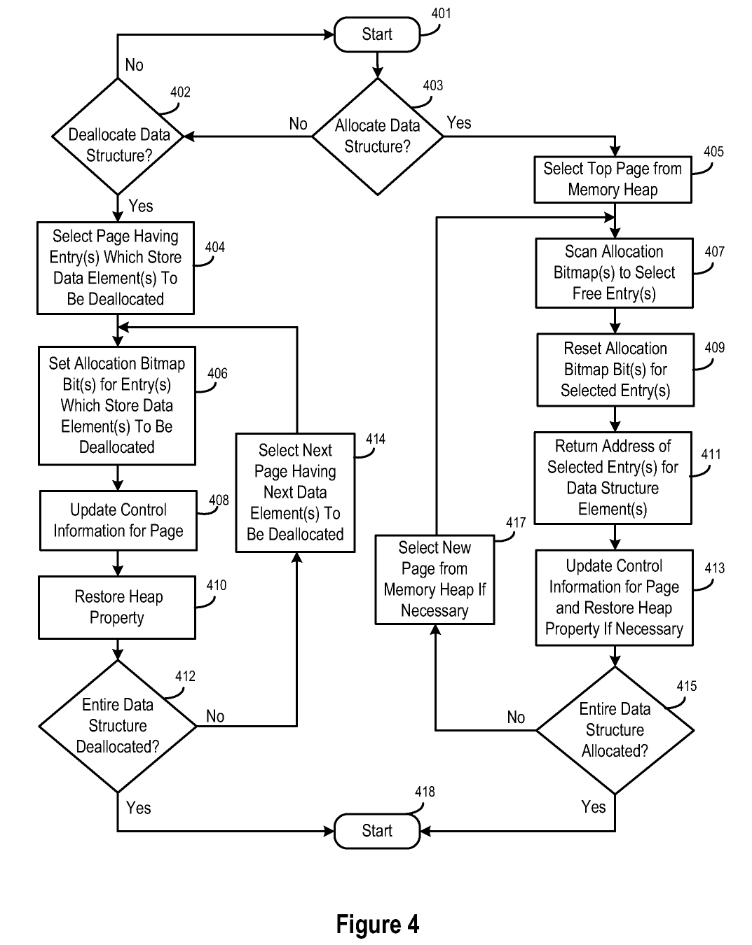

To illustrate how data elements from a data structure can be allocated and deallocated to and from pages in a memory heap, reference is now made to the process flow depicted in FIG. 4. Starting at step 401, when a request is made to allocate a data structure formed from one or more data elements (affirmative outcome of decision 403), the allocation process begins by selecting the top page from the memory heap (step 405), where the memory heap of pages is structured as a balanced binary tree in which each node (e.g., page) of the tree has an ordering value (e.g., the key value, “numfree”) that is smaller than the ordering value of both of its children. As described herein, the heap property is modified so that the smallest possible ordering value (e.g., numfree=0) is considered to have more free elements than the maximum for a node (252 for the 4K example and 4062 for the 64K example). With this modified heap structure, the page at the top of the modified heap structure is the page with the fewest free, but non-zero, elements.

In the selected page, one or more free entries are located for allocation by scanning one or more allocation bitmaps (step 407). For example, with the linked list example described above, the “long ele_free[*]” direct allocation bitmap may be searched to find the first set bit, I, which identifies a free entry in the bit map. Alternatively, a multi-pass search technique may be used to allocate an entry by first searching an upper layer bitmap (e.g., the “ele_free2[*]” indirect allocation bitmap) for the first set bit, h, which identifies a word in the direct allocation bitmap having at least one free entry. In the second pass, the identified word in the direct allocation bitmap (e.g., ele_free[h]) is searched to locate the first set bit, I, which identifies the element on the page (e.g., element[h*64+I]) that is free and available for allocation. Upon identifying or selecting one or more free entries in the page for allocation (step 407), each selected entry is allocated by re-setting the bit(s) in the allocation bitmap(s) corresponding to the selected entry (step 409). In addition, the address of any selected entry is returned for use in storing one or more data elements from the data structure to the selected entry(s) on the selected page (step 411), though the address information can be returned subsequently. The control information for the selected page is also updated to reflect the allocation and any required restoration of the heap order is performed (step 413). For example, once a free element on a page is identified and allocated, the key value (e.g., numfree) for that page is decremented to reflect that there are fewer free entries after the allocation. If the new key value for the page changes the position of the page in the memory heap, then the references in the control information identifying the parent, child and index information for the page are updated. This can be illustrated with reference to the memory heap depicted in FIG. 3, where an allocation of an entry in a child page (e.g., second page 302 in the heap depicted in FIG. 3) decrements the key value so that it is less than the key value for its parent page (e.g., first page 301). In this case, the heap may be restored by swapping the positions of the child and parent pages (e.g., pages 301, 302) in the heap by revising the control information (e.g., the parent and child pointers and “int heapidx” values) for each page to reflect the new position in the heap. If the top page on the heap is filled by an allocation, its key becomes 0, which is larger than any other key. The heap property is again restored by comparing the key to that of its up to two children, and swapping the index with that of the child with the lowest key value, and fixing up the parent and child pointers to reflect the new location of the page in the heap. This process is repeated until the formerly top page is at the appropriate location in the heap, where it either has no children or its children also have 0 free elements. If all of the data elements from the data structure have not been allocated (negative outcome of decision 415), then the top page is used to allocate the next element unless the top page has no free elements, in which case a new top page is selected from the heap after restoring the heap order on the basis of the key value (step 417) and the process is repeated (starting with step 407) until all of the data elements from the data structure are allocated (affirmative outcome of decision 415), at which point the process returns to the starting point (step 418) to await the next allocation or deallocation request.

An example sequence for handling a deallocation request is also illustrated in FIG. 4. As illustrated, a request to deallocate a data structure is identified (affirmative outcome of decision 402) after determining that an allocation request has not been made (negative outcome of decision 403), though it will be appreciated that this sequence can be reversed, or alternatively the allocation and deallocation processes can be initiated independently of one another. However initiated, the deallocation process begins by identifying or selecting the page having one or more of the entries storing the data elements to be deallocated (step 404). For example, with the linked list example described above, a data element is deallocated by taking the address of the data element and rounding it down to the appropriate page size to identify the start address of the page containing the data element to be deallocated. Next, the allocation bitmap bits are set for each entry which stores a data element to be deallocated (step 406), indicating that the corresponding entries on the page are free. This can be done by calculating the index idx of the element being freed, setting the bit (idx−64*floor(idx/64)) in the direct allocation bitmap (ele_free[floor(idx/64)]), and setting the bit floor(idx/64) in the indirect allocation bitmap (ele_free2). The control information for the selected page is also updated to reflect the deallocation (step 408). For example, once an element on a page is identified and deallocated, the key value (e.g., numfree) for that page is incremented to reflect that there are more free entries after the deallocation. Finally, if the new key value for the page changes the correct position of the page in the memory heap, the heap order is restored (step 410) by revising the control information (e.g., the parent and child pointers and “int heapidx” values) for each page to reflect the new position in the heap. If all of the data elements from the data structure have not been deallocated (negative outcome of decision 412), the next page containing a data element to be deallocated is selected (step 414) and the process is repeated (starting with step 406) until all of the data elements from the data structure are deallocated (affirmative outcome of decision 412), at which point the process returns to the starting point (step 418) to await the next allocation or deallocation request.

As seen from the foregoing, by partitioning the management data so that it is stored non-contiguously on the same page with the data element(s) it is managing, there is no need for a very large set of management data that must also be pinned/bolted to be accessed in the same environment as the data it manages. And by maintaining the memory pages in a modified heap structure such as described herein, data elements can be rapidly allocated, deallocated and reclaimed by exploiting the property of the heap whereby the page at the top of the heap always has the fewest free, but non-zero, elements. This means that a new data element can be allocated in O(1) time (plus O(lg n) to restore the heap property, where “n” is the number of pages in the heap). Similarly, a data element is freed in O(lg n) time, as the heap property must be restored. By always allocating from the page with the fewest free entries, the allocation technique promotes the generation of pages in which all the entries are free. The result is that, to find a page must be freed, it will take O(n) time to find it. At a minimum, the search will locate the page in the heap having the most free entries, and if all of the entries on the located page are not free, then the allocated entries can be swapped with other free entries if needed to generate a page having all free entries.

With the modified heap structure described herein, a new page can be added in O(lg n) time. If the heap structure is organized as an array that starts as index I, then a given heap page “n” has children 2*n and 2*n+1. Starting the indexing at 1 means that the binary value for the heap index is also a left-right travel pattern to locate the node in the heap. For example, consider a heap node 1001010b. The node is reached by traversing the tree left->left->right->left->right->left. With node 1 at the top of the tree, no left/right travel is necessary. The children of node “n” are 2*n and 2*n+1 (or in binary, n0 and n1). The first child is left, the second right. Thus, the time required to add a page and place it in the heap to keep the heap as a balanced binary tree is represented by O(lg n), and the time required to restore the heap order is represented as O(lg n).

As will be appreciated by one skilled in the art, the present invention may be embodied in whole or in part as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. For example, the functions of dynamic memory allocation module may be implemented in software or in a separate memory management unit.

The foregoing description has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification and example implementations provide a complete description of the manufacture and use of the composition of the invention. Since many embodiments of the invention can be made without departing from the spirit and scope of the invention, the invention resides in the claims hereinafter appended.

What is claimed is:

1. A method for allocating a first data structure to memory in a data processing system, comprising:
receiving a request to allocate a first data structure during operation of said data processing system, where the first data structure comprises at least a first data element;
selecting a first page of memory having at least a first free entry that is available for storing at least the first data element of the first data structure in response to receiving said request;
allocating the first free entry for exclusive storage of said first data element; and
updating control information stored on the first page of memory with management data specifying that the first free entry is allocated on said first page.

2. The method of claim 1, where the memory comprises a plurality of memory pages organized in a heap structure where each page in the heap structure is positioned based on a key value associated with each page.

3. The method of claim 2, where the key value for each page identifies how many free entries are contained by the page.

4. The method of claim 1, where selecting a first page of memory comprises selecting a page from a heap of memory pages which is ordered by how many free entries are contained on each page.

5. The method of claim 4, where the heap of memory pages are organized so that a page, having at least one free entry and fewer free entries than any other page in the heap, is located at the top of the heap.

6. The method of claim 1, where allocating the first free entry comprises scanning an allocation bitmap for the first page to select an entry that is available for allocation.

7. The method of claim 1, where allocating the first free entry comprises:
scanning an allocation bitmap for the first page to select an entry that is available for allocation; and
returning an address for an entry selected for exclusive storage of the first data element.

8. The method of claim 6, where scanning an allocation bitmap comprises:
scanning an indirect allocation bitmap to identify a first region in a direct allocation bitmap having at least one free entry; and
scanning the first region in the direct allocation bitmap to identify an entry that is available for allocation.

9. The method of claim 1, where updating control information comprises decrementing a key value for the first page to identify how many free entries are contained by the first page.

10. The method of claim 1, further comprising deallocating a second data structure that is stored, at least in part, in a second entry on a second page of memory by updating control information stored on the second page of memory with management data specifying that the second entry on the second page is deallocated.

11. The method of claim 10, where updating control information comprises:
setting a bit corresponding to the second entry in an allocation bitmap for the second page; and
decrementing a key value for the second page to identify how many free entries are contained by the second page.

12. A computer-usable medium embodying computer program code, the computer program code comprising computer executable instructions configured for allocating a first data structure to memory in a data processing system by:
receiving a request to allocate a first data structure during operation of said data processing system, where the first data structure comprises at least a first data element;
selecting a first page of memory having at least a first free entry that is available for storing at least the first data element of the first data structure in response to receiving said request;
allocating the first free entry for exclusive storage of said first data element; and
updating control information stored on the first page of memory with management data specifying that the first free entry is allocated on said first page.

13. The computer-usable medium of claim 12, where selecting a first page of memory comprises selecting a page from a heap of memory pages which is ordered by how many free entries are contained on each page.

14. The computer-usable medium of claim 14, where the heap of memory pages are organized so that a page, having at least one free entry and fewer free entries than any other page in the heap, is located at the top of the heap.

15. The computer-usable medium of claim 12, where allocating the first free entry comprises scanning an allocation bitmap for the first page to select an entry that is available for allocation.

16. The computer-usable medium of claim 12, wherein the embodied computer program code further comprises computer executable instructions configured for:
deallocating a second data structure that is stored, at least in part, in a second entry on a second page of memory by updating control information stored on the second page of memory with management data specifying that the second entry on the second page is deallocated.

17. A data processing system comprising:
a processor;
a data bus coupled to the processor; and
a computer-usable medium embodying computer program code, the computer-usable medium being coupled to the data bus, the computer program code comprising instructions executable by the processor and configured for allocating a first data structure to memory in the data processing system by:
receiving a request to allocate a first data structure during operation of said data processing system, where the first data structure comprises at least a first data element;
selecting a first page of memory having at least a first free entry that is available for storing at least the first data element of the first data structure in response to receiving said request;
allocating the first free entry for exclusive storage of said first data element; and
updating control information stored on the first page of memory with management data specifying that the first free entry is allocated on said first page.

18. The data processing system of claim 17, where selecting a first page of memory comprises selecting a page from a heap of memory pages which is ordered by how many free entries are contained on each page.

19. The data processing system of claim 18, where the heap of memory pages are organized so that a page, having at least one free entry and fewer free entries than any other page in the heap, is located at the top of the heap.

20. The data processing system of claim 17, where allocating the first free entry comprises scanning an allocation bitmap for the first page to select an entry that is available for allocation.
